(19) United States
(12) Patent Application Publication
(10) Pub. No.: US 2012/0105230 A1
(43) Pub. Date: May 3, 2012

(54) ANTI-THEFT SENSOR SYSTEM

(76) Inventors: Thomas Bockstoce, Akron, OH (US); Fayaz Khatri, Macedonia, OH (US)

(21) Appl. No.: 13/282,543

(22) Filed: Oct. 27, 2011

Related U.S. Application Data
(60) Provisional application No. 61/407,192, filed on Oct. 27, 2010.

(51) Int. Cl. G08B 13/14; H01B 7/00; D04C 1/02

(52) U.S. Cl. 340/568.2; 87/9; 174/115

(57) ABSTRACT

An antitheft sensor system includes a covering which is placed around an object to be protected (such as a cable). Sensor wires are located in the covering. Signals are sent through the sensor wires and the wires are monitored for changes in the signals (such as changes in wire resistance) that may indicate theft or tampering. The system allows determination of theft or tampering of objects which may be operated only infrequently, such as conductors bridging rails.

This application claims priority under 35 USC 119 from U.S. Provisional Application No. 61/407,192, filed Oct. 27, 2010, which is incorporated herein in its entirety.

### BACKGROUND OF THE INVENTION

1. Field of the Invention

The invention is in the field of anti-theft systems and devices, for protecting objects, for example cables, from theft or tampering.

2. Description of the Related Art

The theft of copper conductors are a great nuisance and costly to operation of the end user. Many others have developed cable theft deterrents. For example SmartWater® and SelectaDNA™ (Selectamark Security Systems plc) have developed a DNA forensic liquid/grease. It is applied to the conductor and the liquid/grease transfers to the thief handling the conductor. Under UV light the liquid/grease will show up. The liquid/grease remains on the thief after numerous washes so it can be forensically analyzed for evidence in the court of law. Also, Network Rail Infrastructure, TEW Plus Ltd. is using an intruder deterrent system that uses sensors to trigger a Derwent System using AEIGUS White Light LED illuminators and loudspeaker to warn trespassers to leave the site.

However, none of these systems can verify the presence of the conductor, detect the removal, or send a remote alarm at the initial disruption (cut, break, etc.). The end user is unaware that a cable is missing until the cable is needed to carry the power to the desired application. This is too late and can shutdown the operation or overload other cables in the system, which could have health and safety implications.

It will be appreciated that further improvements in this field of endeavor would be desirable.

### SUMMARY OF THE INVENTION

According to an aspect of the invention, a braided sleeve combines both non-conductive and conductive materials. Some strands of the braid are made of conductive material, and other strands of the braid are made of non-conductive material.

According to another aspect of the invention, a sensor sleeve material can be used with both new and existing constructions.

According to yet another aspect of the invention, insulated conductors are weaved into a non conductive braided sleeve.

According to still another aspect of the invention, securing couplers are used to prevent tampering of sleeve terminations and for terminating or coupling sense wires.

According to a further aspect of the invention, sensors continuously monitor the presence or absence of a conductor by monitoring the resistance and comparing it to an initial resistance.

According to a still further aspect of the invention, sensors can be calibrated for any range of conductor length.

According to another aspect of the invention, a sensor system includes: a braided sleeve having sensor wires therein; and a sensor for determining if one or more of the sensor wires are severed or otherwise disturbed. The sensor system may include one or more of the following additional features, portions of which may be combinable with each other: the sensor wires include electrically-conductive sensor wires; the electrically-conductive sensor wires are coated by an insulator; the sensor wires include fiber optic sensor wires; the sleeve includes non-sensor strands braided in with the sensor wires; the sensor wires may have spiral shapes, wrapping spirally around a cylindrical interior space enclosed by the braided sleeve, thereby having a helix shape; the sensor wires includes one or more pairs of sensor wires; the pairs of sensor wires make a double helix shape as they are spirally located around a cylindrical interior space enclosed by the sleeve; the pairs of sensor wires are substantially 180 degrees apart from one another (although the sensor wires may be along a circumference at other angles); the pairs of sensor wires are wrapped in opposite directions about an axis of the sleeve; the sleeve can expand or contract, such as by +/−20%; the sleeve surrounds a cable; the sleeve surrounds at least portions of fittings on the ends of the cable; couplers are secured to ends of the sleeve; the couplers are adhesion couplers; the couplers are filled with an epoxy, potting compound, or other liquid adhesive material; the couplers are permanently attached to the ends of the sleeve; the sensor wires are connected to a slave sensor; the sensor wires of other sleeves are connected to the slave sensor; the slave sensor includes a current source that supplies a current to sensor wires; the current is a substantially constant current; the slave sensor examines the voltage drop across the sensor wires to determine changes in resistance of the sensor wires; the slave sensor is operatively coupled to a master/communication sensor; one or more additional slave sensors are coupled to the master/communication sensor; the master/communication triggers an alarm based on input from the one or more slave sensors; the sensor system functions as an anti-theft system.

According to yet another aspect of the invention, a sleeve includes: nonconductive material; and sensor wires within the nonconductive material. The sleeve may include one or more of the following features: the nonconductive material includes nonconductive strands; the sensor wires are braided within the nonconductive strands; the sensor wires include electrically-conductive sensor wires; the electrically-conductive sensor wires are coated by an insulator; the sensor wires include fiber optic sensor wires; the sensor wires have spiral shapes, wrapping spirally around a cylindrical interior space enclosed by the sleeve, thereby having a helix shape; the sensor wires includes one or more pairs of sensor wires; the pairs of sensor wires make a double helix shape as they are spirally located around a cylindrical interior space enclosed by the sleeve; the pairs of sensor wires are substantially 180 degrees apart from one another (although the sensor wires may be along a circumference at other angles); the pairs of sensor wires are wrapped in opposite directions about an axis of the sleeve; the sleeve can expand or contract, such as by +/−20%.

According to still another aspect of the invention, a method of protecting a cable or other conductor from theft comprises: placing a sleeve containing sensor wires over the cable or other conductor; and monitoring the sensor wires. The method may also include one or more of the following features: the monitoring includes monitoring resistance of the sensor wires; the monitoring includes running a substantially constant current through the sensor wires, and measuring a voltage drop; the sleeve is a braided sleeve; the placing includes placing the sleeve over terminations at ends of the cable or other conductor; further including securing the sleeve in place using couplers; the couplers are adhered to the cable by an adhesive or another suitable material.

According to another aspect of the invention, a sensor system for protecting an object, the system includes: a covering around the object, wherein the covering has sensor wires therein; and a sensor operatively coupled to the sensor wires, for determining if one or more of the sensor wires are severed or otherwise disturbed.

According to yet another aspect of the invention, a theft-resistant cable includes: wire strands; and a covering surrounding the wire strands, wherein the covering includes one or more pairs of sensor wires therein that surround the wire strands.

According to still another aspect of the invention, a method of protecting an object from theft includes: providing a covering with sensor wires around the object to be protected; and monitoring the sensor wires for changes in signals running through the sensor wires.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various aspects of the invention.

FIG. 1 is an oblique view of an installation of a sensor system in accordance with an embodiment of the invention.

FIG. 2 is a view of a sensing sleeve of the system of FIG. 1, over the end of a cable.

FIG. 3 is another view of the sensing sleeve of FIG. 2.

FIG. 4 is a schematic view showing part of the system of FIG. 1.

FIG. 5 is a block diagram showing an embodiment of the sensor of the system of FIG. 1.

FIG. 6 is a table showing some possible sizes for the sleeves.

FIG. 7 is a view of an alternate embodiment antitheft covering according to the invention.

FIG. 8 is a cross-sectional view of the covering of FIG. 7, surrounding a cable.

### DETAILED DESCRIPTION

A cable theft sensor system is configured to monitor and notify when a conductor is missing/stolen. The cable theft sensor system continuously monitors the resistance of insulated conductors woven into a braided sleeve. A change in resistance triggers an alarm notifying end users of possible disturbance to the system being protected. The insulated conductors are woven into the sleeve in opposite directions to maximize coverage. The braided sleeve is pulled over a conductor and secured at both ends to the conductor that is monitored. The system is independent from the existing conductor and leaves the conductor unaltered. The product can be used on existing conductors with lugs, as well as on new installations.

This device was designed to indicate a break/cut, by sensing the change in resistance, on a cable and notify the end user that the conductor was removed. The sensor may trigger a NO/NC (Normally Open/Normally Closed Contacts) alarm contacts to alert that the circuit has lost a conductor. The NO/NC contacts can trigger an audible alarm, send a instant message, alarm back to central control, etc. As an alternative to triggering an alarm, the sensor may send a signal providing notification of tampering/removal, for example with a signal having a communication protocol.

An antitheft sensor system includes a covering which is placed around an object to be protected (such as a cable). Sensor wires are located in the covering. Signals are sent through the sensor wires and the wires are monitored for changes in the signals (such as changes in wire resistance) that may indicate theft or tampering. The system allows determination of theft or tampering of objects which may be operated only infrequently, such as conductors bridging rails.

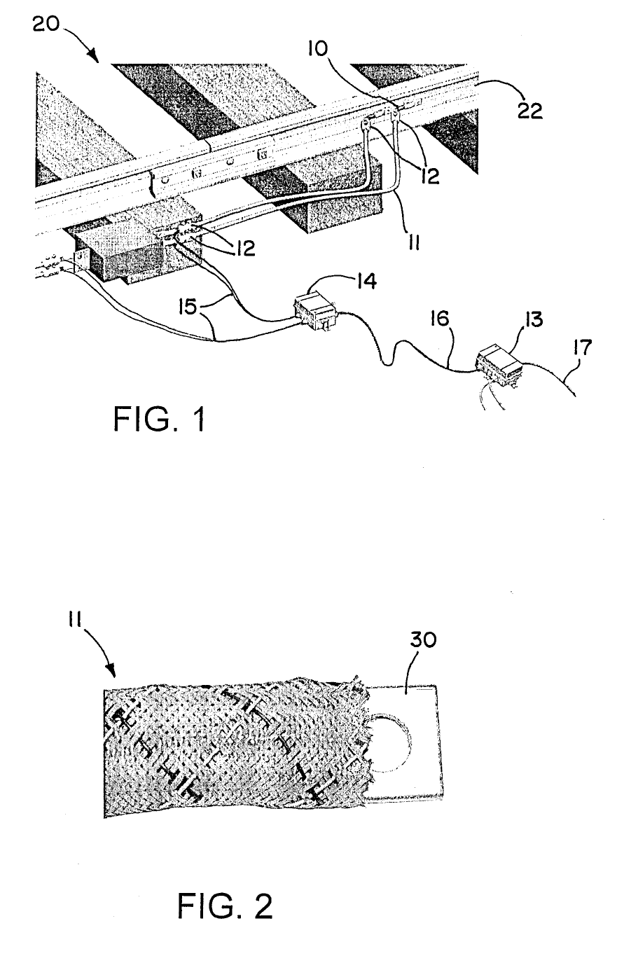

Referring now to FIG. 1, a cable (and possibly other conductors) 10 is protected by and is covered by the weaved sensing sleeve 11. The sensing sleeve 11 is secured to the conductors of the cable by two or more adhesion couplers 12 to prevent the sleeve from being pulled back and conductors of the cable 10 being cut and removed without cutting the sensing sleeve 11. The insulated conductors (sensor wires) of the sensing sleeve 11 then feed into a slave sensor 14 by sensing sleeve return conductors 15. Then multiple slave sensors 14 feed into a master/communication sensor 13 by the slave to master conductor 16. The master sensor 13 then triggers the alarm contacts to alert that the circuit has lost a conductor. This alarm is sent through the NO/NC (Normally Open/Normally Closed Contacts) Alarm conductors 17.

Various of the connections are shown in FIG. 1 as wired connections. However, some or all of the electrical connections may be wireless connections, such as for sending an alarm signal to a remote location.

In order to install the sensing sleeve 11, the sensing sleeve 11 is slid over the cable 10. For insulation on existing cable one end of the cable needs to be removed and the sensing sleeve 11 is pulled over that end all the way back to the other end. The cable is then reconnected.

The adhesion couplers 12 are placed over the sensing sleeves 11. It may have an epoxy, potting compound, or other liquid adhesive material poured into the coupler 12 to make a solid connection so the sleeve 11 cannot be pulled back or the sense wire connections altered. The coupler 12 is intended to be permanently attached onto the sleeve 11 and/or the conductor (cable 10), such as by use of a suitable adhesive or other material.

The parts 11-17 together constitute a cable anti-theft sensor system 20. The system 20 is used for protecting a series of cables such as the cable 10. The cable 10 is shown as connected to a rail 22. It will be appreciated that the cable connections may be made to the rail for any of a variety of reasons. It will be further appreciated that the sensor system may be used for other sorts of electrical connections. To give a few examples, electrical connections at a cell phone tower, grounding wire, or electrical power device may be protected. The sensor system 20 may be used for anti-theft purposes, or for other purposes of confirming the integrity of a cable or other conductor. The sensor system 20 may also be used for protecting against theft and/or against tampering a wide variety of other items, which may or may not be electrically conductive.

FIG. 2 shows the flexibility of the braided sleeve 11. The braided sleeve is around a circular cable (not shown), and also can change shape to fit over a termination 30. The braided sleeve 11 can expand and contract, for example +/−20% to fit over existing terminations, and/or other objects.

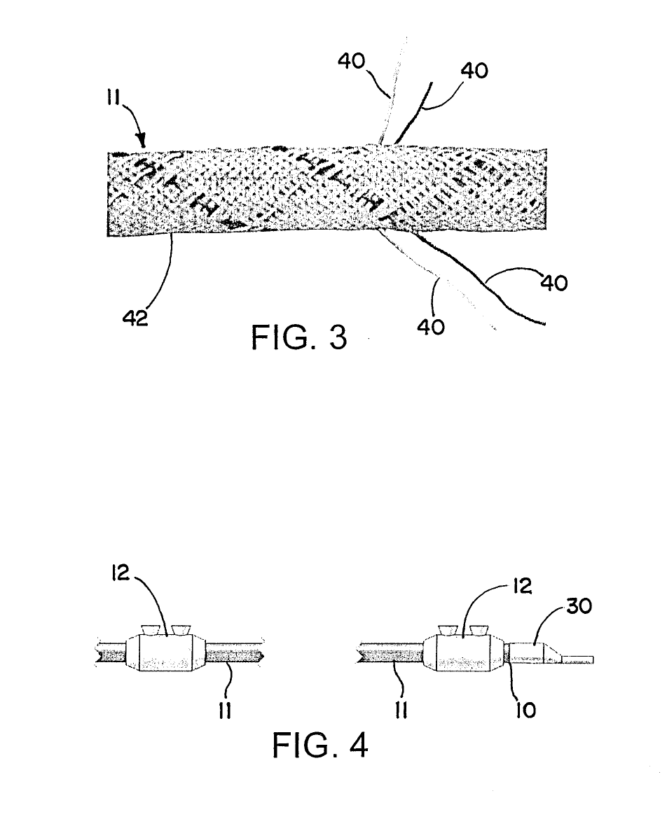

FIG. 3 shows some details of the braided sleeve 11. Insulated sensing conductors 40 are weaved in among non-conductive weaved strands 42. The sensing conductors 40 are conductive wires surrounded by insulating material, such as a suitable plastic. The conductive wires may be copper or another suitable conductor. The non-conductive strands 42 may be strands of suitable insulating material, such as a suitable plastic. The insulating material of around the sensing conductors 40, or in the non-conductive strands 42, may be made from polyamide, polyester, nylon, or other materials. The pairs of sensing conductors 40 are weaved in opposite orientation to maximize the coverage and to prevent the conductor being protected to be cut. By having them in opposite directions, such as 180 degrees apart (or at another angle), a thief is unable to cut around the sensing conductors 40 to get the main protected conductor (the cable 10 (FIG. 1) or other enclosed conductor) without cutting the sensing conductors 40.

FIG. 4 shows the connection of the couplers 12 to ends of the braided sleeve 11. The couplers 12 are attached to the sensing sleeve 11 to prevent tampering. The couplers 12 may be made of a suitable material, such as a suitable plastic. The couplers 12 may be mechanically adhered to the cable inside the sleeve 11 by use of a suitable adhesive.

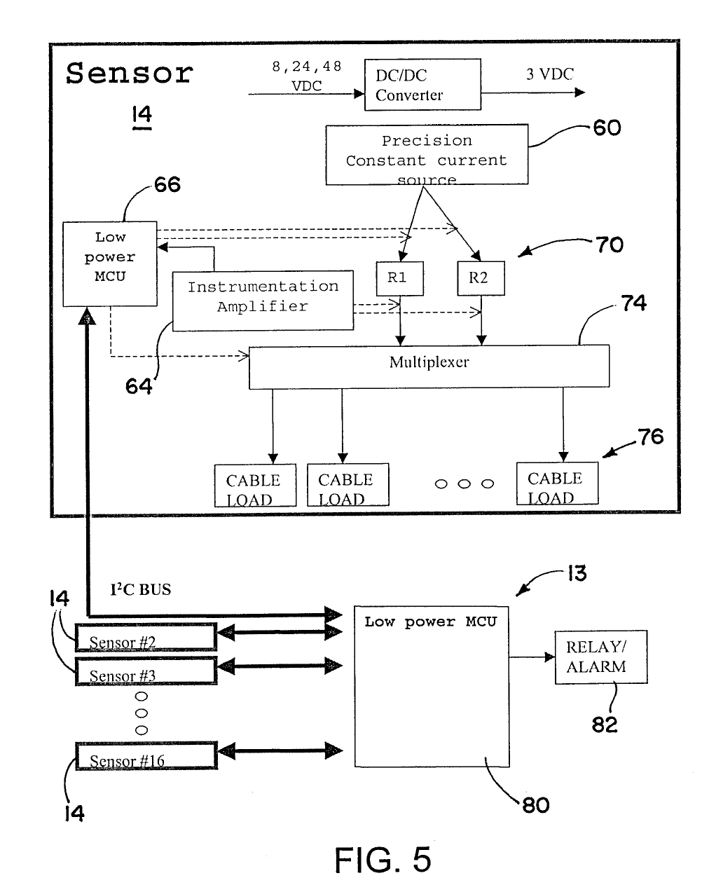

FIG. 5 is a block diagram of the sensors 13 and 14. In the slave sensor 14 a precision current source 60 supplies a constant current to the sensing conductors 40 (FIG. 3). The voltage drop across these conductors 40 is fed into an instrumentation amplifier 64 and finally into a microprocessor (the microcontroller unit (MCU) 66) through an analog-to-digital converter. Various ranges of resistances (corresponding to different lengths of sensing conductors) can be measured by varying the value of the set resistance 70 of the current source. A multiplexer 74, controlled by the microprocessor 66, selects which cable load 76 needs to be measured. So even if the sense sleeve conductors 40 are jumpered and attempted to be removed the system 20 (FIG. 1) will detect the change in resistance, and trigger an alarm.

Several slave sensors 14 are coupled to the master sensor 13, which has a low power MCU 80 that detects an alarm condition in one of the slave sensors 14. The master sensor 13 then sends a suitable alarm 82, indicating theft, tampering, or damage in one or more of the conductors (e.g., cables) being monitored.

The system 20 (FIG. 1) has advantages over other possible antitheft systems (which are not necessarily in the prior art). To give one example, a cable with a sensor wire pre-manufactured into insulation sleeve can only be used for new applications unlike our proposed system. Also, such a cable must be used for that ampacity it was designed for unlike the proposed sleeve solution that can expand and contract to fit over various conductor ranges.

To give another example, using a current sensor to verify that the conductor still exists by sensing the current being used in the system will only work when the system is running and it can sense the current being used by the end application. If the end application conductors are being monitored is shut down then no current will be used and system will indicate a false failure.

As yet another example, overlaying frequency onto a conductor to confirm the conductors exist may cause unknown failures to the system by running at the similar or same frequency of embedded controllers or other devices in the system.

As still another example, composite cable could be used to deter conductor theft because the cable has no scrap value. However, this solution does not give feedback the conductors were removed.

It will be appreciated that there may be other uses for the sensor system or parts thereof. For example the sensor could monitor temperature, pressure, sound, vibration, etc.

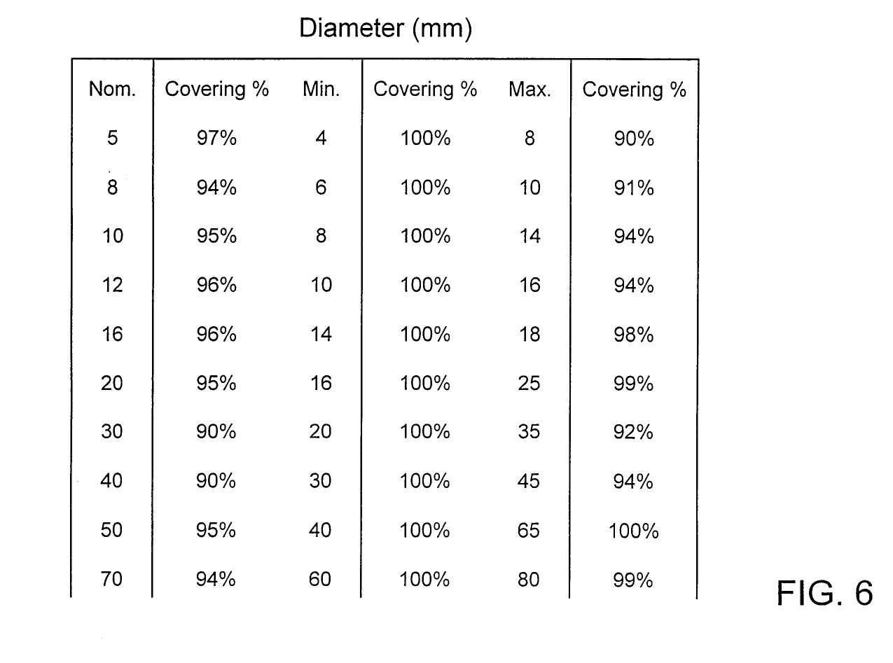

The sleeves 11 (FIG. 1) can come in a large range of sizes. FIG. 6 is a table showing some possible sizes.

As an alternative to the electrically-conductive insulation-coated sensor wires 42 (FIG. 3) described above, the sensor wires may be fiber optic devices, such as fiber optic cables or filaments. The term “sensor wires” should be understood as encompassing both electrically-conductive sensor wires and fiber optic sensor wires. It will be appreciated that a system with fiber optic sensor wires may utilize appropriate sensors for sending, detecting, and interpreting signals in fiber optic sensor wires.

It will be appreciated that the sleeves 11 (FIG. 1) can be put over a variety of devices (objects). Non-limiting examples of devices (objects) are copper pipe, buss bar, or other valuable devices (devices for example having scrap or other value).

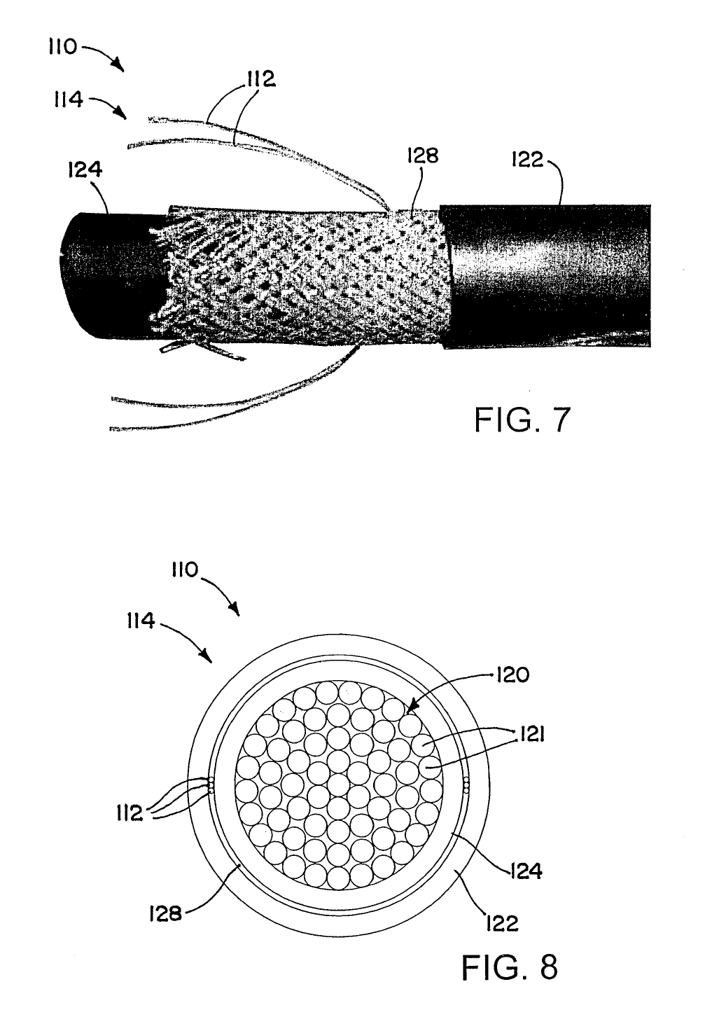

FIGS. 7 and 8 show an alternative configuration, a sensor system 110 that includes sensor wires 112 that are embedded in a covering 114 around an object to be projected, such as from theft or tampering. The object in the illustrated embodiment is a cable 120 that includes many wire strands 121, but the object may alternatively be any of a wide variety of other objects. Examples include objects of any of a wide variety of forms, such as cables or wires for any of a variety of uses, and other elongate objects such as rods or pipes. The objects may be made of electrically-conducting material or electrically-non-conducting material.

The sensor wires 112 are between an outer jacket 122 of the covering 114, and an inner insulation layer 124 of the covering 114. The sensor wires 112 may include one or more pairs of sensor wires, with multiple pairs of sensor wires for example 180 degrees (or another angle) offset from one another. The jacket 122 and the insulation layer 124 may be made of suitable materials, such as a suitable plastic or rubber. Polyethylene terephthalate (PET) material, such as that sold under the trademark MYLAR, may be wrapped around the braided cable 120, between the cable 120 and the inner layer 124.

The outer jacket 122 may be made of an opaque material, such as a black plastic. This may hide the locations of the sensor wires 112 that are wrapped around the inner layer 124, for example spirally, between the inner layer 124 and the outer jacket 122. This may make difficult tampering with the covering 114 in an attempt to defeat the sensor system 110, for example by cutting off the covering 114 without disturbing the sensor 112, since the sensor wires 112 are hidden from view.

The sensor wires 112 may have any of the various configurations described above for other embodiments. For example the sensor wires 112 may be in a braided sensing sleeve 128, similar in configuration to the sensing sleeve 11 (FIG. 1). The sensor wires 112 may be electrically conductive wires, for example being made of copper or another suitable electrically conductive material. Alternatively the sensor wires 112 may be fiber optic wires.

The covering 114 may be permanently secured to the cable 120, for example by the covering 114 being tightly fit around the cable 120 as part of a manufacturing process. The covering 114 and the cable 120 may be sold as parts of a retrofit or new installation device that is usable in place of a standard unprotected cable.

Other components of the sensor system 110 may be similar to those of the sensor system 20 (FIG. 1). For example the sensor system 110 may include sensors similar to the master/communication sensor 13 (FIG. 1) and the slave sensor 14 (FIG. 1).

Tampering or theft may be detected by sending signals along the sensor wires, and monitoring for changes in output that would indicate tampering or theft. For electrical signals, the monitoring of signals may include monitoring of any of a variety of characteristics of the signals. For example, as stated earlier, the monitoring may be a monitoring of resistance (or current or voltage) to determine changes in resistance of the sensor wires. As other examples, the sensor may monitor for changes in phase angle of signals, impedance changes, and/or frequency changes.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A sensor system for protecting an object, the system comprising:
a covering around the object, wherein the covering has sensor wires therein; and
a sensor operatively coupled to the sensor wires, for determining if one or more of the sensor wires are severed or otherwise disturbed.

2. The sensor system of claim 1, wherein the covering includes a braided sleeve having the sensor wires therein.

3. The sensor system of claim 1, wherein the covering has the sensor wires inside a jacket.

4. The sensor system of claim 3, wherein the sensor wires are between the jacket and an inner layer that is surrounded by the jacket.

5. The sensor system of claim 3, wherein the sensor wires are in a braided sleeve.

6. The sensor system of claim 1, wherein the covering includes a solid flexible material, with the sensor wires embedded in the solid flexible material.

7. The sensor system of claim 1, wherein the sensor wires include one or more pairs of sensor wires.

8. The sensor system of claim 7, wherein the pairs of sensor wires are wrapped in opposite directions about an axis of the covering.

9. The sensor system of claim 1, further comprising couplers secured to opposite ends of the covering.

10. The sensor system of claim 1, wherein the sensor wires include electrically-conductive sensor wires.

11. The sensor system of claim 10, wherein the sensor sends electrical signals along the sensor wires, and monitors for changes in those signals.

12. The sensor system of claim 11, wherein the sensor monitors for changes in resistance of the sensor wires.

13. The sensor system of claim 1, wherein the sensor wires include fiber optic sensor wires.

14. The sensor system of claim 1, in combination with the object to be protected.

15. The combination of claim 14, wherein the object is an electrical cable having wire strands.

16. The combination of claim 14, wherein the object is made of conductive material.

17. A theft-resistant cable comprising:
wire strands; and
a covering surrounding the wire strands, wherein the covering includes one or more pairs of sensor wires therein that surround the wire strands.

18. A method of protecting an object from theft comprises:
providing a covering with sensor wires around the object to be protected; and
monitoring the sensor wires for changes in signals running through the sensor wires.

19. The method of claim 18, wherein the monitoring includes monitoring resistance of the sensor wires;

20. The method of claim 18, wherein the monitoring includes running a substantially constant current through the sensor wires, and measuring a voltage drop through the sensor wires.
